(19) United States
(12) Patent Application Publication
(10) Pub. No.: US 2026/0309920 A1
(43) Pub. Date: Oct. 8, 2026

(54) SILICON NITRIDE WAVEGUIDE OR PHOTONIC INTEGRATED CIRCUIT FABRICATION METHOD

(71) Applicant: ECOLE POLYTECHNIQUE FEDERALE DE LAUSANNE (EPFL), Lausanne (CH)

(72) Inventors: Tobias KIPPENBERG, St-Sulpice (CH); Xinru JI, Ecublens (CH); Rui Ning WANG, Morges (CH)

(21) Appl. No.: 19/481,444

(22) PCT Filed: May 3, 2024
(86) PCT No.: PCT/IB2024/054310

§ 371 Date: Nov. 4, 2025

(30) Foreign Application Priority Data
May 5, 2023 (EP) 23171876.8

(51) Int. Cl. G02B 6/136; G02B 6/12; G02B 6/132

(52) U.S. Cl. CPC G02B 6/136; G02B 6/132; G02B 2006/12038; G02B 2006/121; G02B 2006/12169; G02B 2006/12173

(57) ABSTRACT

Silicon nitride waveguide fabrication method including providing a substrate including a stress release trench structure, the stress release recess structure being formed in a silicon oxide layer, depositing a silicon nitride material or layer onto the silicon oxide layer, providing a silicon oxide hard mask on the deposited silicon nitride material or layer to provide an exposed surface delimited by the silicon oxide hard mask and defined by the deposited silicon nitride material or layer, the silicon oxide hard mask including or defining an elongation extending on the deposited silicon nitride material or layer, dry etching the exposed surface a silicon nitride elongated waveguide core located between the silicon oxide hard mask and the silicon oxide layer in which the stress release trench structure is formed; and depositing a silicon oxide cladding layer on the silicon oxide hard mask to form a cladding structure of the silicon nitride waveguide.

### CROSS-REFERENCE TO RELATED APPLICATIONS

The present application claims priority to the European Application EP23171876.8 that was filed on May 5 2023, the entire contents thereof being herewith incorporated by reference.

### FIELD OF THE INVENTION

The present invention relates to an optical waveguide preparation or fabrication method, or a photonic integrated circuit (PIC) fabrication method. The present invention more particularly concerns a preparation or fabrication method, or a photonic integrated circuit (PIC) fabrication method including one or more silicon nitride optical waveguides. The present invention concerns wafer-scale manufacturing of silicon nitride optical waveguides or photonic integrated circuits including such waveguides.

### BACKGROUND

High-Q Si₃N₄ microresonators are the central elements for Kerr nonlinear photonics, as well as frequency agile low noise lasers, or traveling-wave parametric amplifiers. The ultralow propagation loss greatly facilitates the soliton formation, allowing high sensitivity, narrow bandpass and low power consumption in applications such as optical communications, ultrafast ranging, or spectroscopy, amongst others. These applications usually require operation in the anomalous dispersion regime, where the Si₃N₄ waveguide thickness typically exceeds 600 nm.

To date, high-Q tightly confining Si₃N₄ microresonators with such thickness have been routinely achieved using the photonic Damascene reflow process, where Si₃N₄ is deposited onto a reflowed waveguide preform with improved sidewall roughness, as described in US2016/0327743. However, devices can suffer from inaccurate dimensional transfer as a result of the undercut created in hard mask etching for the waveguide preforms.

Another fabrication process, the subtractive process, where waveguides are patterned and etched directly after Si₃N₄ film deposition, is more commonly used to fabricate photonic integrated circuits based on a wide range of material platforms. This process is inherently simpler and offers acceptable dimension accuracy. However, notable drawbacks include the fact that an etching process needs to be specifically developed for each material, and cracks occur in thick films with large stress. To address the stress issue, methods such as two-time film deposition and annealing are applied to release the large stress in Si₃N₄ films. However, these introduce process complexity and lower the efficiency of the process.

Moreover, to date, the lowest loss Si₃N₄ photonic integrated circuits PICs require electron-beam (e-beam) lithography which is incompatible with wafer scale fabrication (“High-Q SigNA microresonators based on a subtractive processing for Kerr nonlinear optics”, Zhichao Ye et al., Optics Express 27, no. 24 (2019 ): 35719-35727).

The artilce entitled “Stress-released Si₃N₄ fabrication process for dispersion-engineered integrated silicon photonics”, by WU KAIYI ET AL, published in OPTICS EXPRESS, vol. 28, no. 12, 28 May 2020 (2020 -05-28), page 17708 discloses using a SiO₂ hard mask that is etched to fully remove the SiO₂ hard mask. This is assured by over-etching. This article also discloses that maintaining over-etching to within 5% minimizes the impact of over-etching on surface roughness.

A goal of the present invention is to provide a solution to these inconveniences, and in particular, to provide an alternative method that overcomes the above-mentioned inconveniences and assures the provision of ultra-low propagation loss silicon nitride waveguides and photonic integrated circuits.

### SUMMARY

It is therefore one aspect of the present disclosure to provide a silicon nitride waveguide preparation or fabrication method, or a silicon nitride photonic integrated circuit fabrication method according that addresses the above-mentioned inconveniences and needs.

The silicon nitride waveguide fabrication method or the silicon nitride photonic integrated circuit fabrication method may include:
providing a substrate including at least one stress release trench structure for receiving a waveguide material, the at least one stress release recess structure being formed in a silicon oxide layer or material;
depositing a silicon nitride material or layer onto the silicon oxide layer or material and into the at least one stress release recess structure;
providing at least one silicon oxide hard mask on the deposited silicon nitride material or layer to provide at least one exposed surface delimited by the at least one silicon oxide hard mask and defined by the deposited silicon nitride material or layer, the at least one silicon oxide hard mask including or defining at least one elongation extending on the deposited silicon nitride material or layer;
dry etching the at least one exposed surface to form at least one silicon nitride elongated waveguide core located between the at least one silicon oxide hard mask and the silicon oxide layer or material in which the at least one stress release trench structure is formed; and
depositing a silicon oxide cladding layer or material on the at least one silicon oxide hard mask, subsequent to the step of dry etching, to form a cladding structure of the silicon nitride waveguide.

The present disclosure also concerns a silicon nitride waveguide, and a silicon nitride photonic integrated circuit substrate produced or provided by the above method.

The method permits to fabricate wafer-scale ultra-low loss, high confinement silicon nitride optical waveguides and photonic integrated circuits with an optimized subtractive process/method. Advantageously, the method can feature only one deposition step for the Si₃N₄ film.

The Inventors demonstrate the fabrication of Si₃N₄ optical waveguides and photonic integrated circuits featuring ultra-low propagation loss and tight optical confinement, fabricated with the subtractive process of the present disclosure.

The Inventors also demonstrate that an increase in propagation loss in Si₃N₄ waveguides after exposure to ultraviolet (UV) irradiation may occur, and that such loss can be recovered by a rapid thermal anneal (RTA). An intrinsic quality factor as high as 20×10⁶ at 1.55 μm across a 100 mm wafer can already be achieved using the fabrication method of the present disclosure. The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1A shows some exemplary steps of an exemplary waveguide preparation or fabrication method of the present disclosure, or a photonic integrated circuit (PIC) fabrication method according to the present disclosure.

FIG. 1B shows a patterned hard mask on a silicon nitride layer or material at an intermediate stage of the exemplary optical waveguide preparation or fabrication method, or photonic integrated circuit (PIC) fabrication method according to the present disclosure.

FIG. 2 is a scanning electron microscopic image of filler patterns or stress release trench structures in a silicon oxide layer after etching of the silicon oxide layer but prior to deposition of silicon nitride, for example, corresponding to the stage indicated by the number 2 in FIG. 1A.

FIG. 3 is a scanning electron microscopic image of elongated silicon nitride waveguides after etching of the silicon nitride core waveguide material with the silicon oxide hard mask remaining on top of the elongated silicon nitride waveguide core material, corresponding to the stage indicated by the number 5 in FIG. 1A. The filler patterns or stress release trench structures are also shown filled with silicon nitride and have stopped the cracks in the structure or the silicon oxide from propagating to the waveguides, as shown in the upper left part of the image.

FIG. 4A is a side-view scanning electron microscopic image of a silicon nitride waveguide after etching using the silicon oxide hard mask to remove surrounding silicon nitride material, corresponding to the stage indicated by the number 5 in FIG. 1A. The porous top part or top surface in the image is the outer or top surface of the silicon oxide hard mask after silicon nitride waveguide etching. The pores will be filled during cladding deposition. A smooth side wall of the silicon nitride waveguide extending downwards from the top surface to the thermal silicon oxide are also visible in the image.

FIG. 4B is another side-view scanning electron microscopic image of the etched waveguide showing the pores on the top surface of SiO₂ hard mask resulting from chemical reactions with the CxFy etchants. The smooth sidewall of the etched waveguide is also visible in the image. FIGS. 5A and 5B show etching end point graphs of a Si₃N₄ waveguide with two Si₃N₄ deposition steps (FIG. 5A) and with a single Si₃N₄ deposition step (FIG. 5B). In FIG. 5A, an end point in the middle of the waveguide etching is a clear evidence that the boundary or interface is present between the two Si₃N₄ deposited layers, this is absent in single deposition layer of FIG. 5B. This boundary or interface produced by the two step deposition process can result in undesired property changes in the SisN4 waveguide compared to that of the Si₃N₄ layer deposited in a single deposition step.

FIG. 6 is a scanning electron microscopic image of a cross section of a silicon nitride waveguide after cladding deposition onto the silicon oxide hard mask and the silicon nitride elongated waveguide core material, corresponding to the stage indicated by the number 7 in FIG. 1A. The sidewall angle of the exemplary silicon nitride waveguide is 87 degrees, and the silicon nitride waveguide has an exemplary thickness of 720 nm and a width of 2000 nm. FIG. 7A is a histogram of fitted intrinsic linewidth of fabricated waveguide or resonator devices before a rapid thermal treatment and FIG. 7B is a histogram of fitted intrinsic linewidth after rapid thermal treatment.

FIGS. 8A to 8D show linear loss measurements of fabricated silicon nitride microresonators with a FSR of 50 GHz. FIGS. 8A and 8B show the intrinsic linewidth distribution and histogram across 1350-1650 nm; while FIGS. 8C and 8D show loss and dispersion dependence on waveguide width.

FIG. 9A shows a DUV stepper exposure layout across the wafer, and the most probable value κ₀/2π of the ring resonator at different positions of the wafer; and FIG. 9B shows a recorded resonance with linewidth fitting at 1549.4 nm. The intrinsic loss rate κ₀/2π is extracted as 9.59 MHz, corresponding to a quality factor of 20.17 million.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

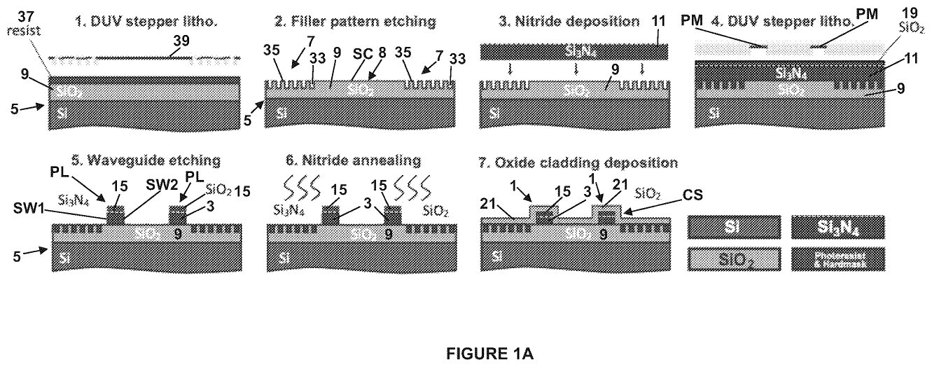

FIG. 1A shows an exemplary fabrication method according to the present disclosure. FIG. 1A schematically illustrates some exemplary steps of a waveguide 1 preparation or fabrication method of the present disclosure, or a photonic integrated circuit (PIC) 1 fabrication method according to the present disclosure.

The method is an optical waveguide 1 or optical waveguide device 1 preparation or fabrication method, an in particular, a silicon nitride waveguide 1 preparation or fabrication method.

The same method can be used for the fabrication of a photonic integrated circuit that comprises one or more silicon nitride waveguides 1, and may also include other devices or elements The optical waveguide 1 and the waveguide core 3 extend in an elongated manner (see, for example, FIG. 3) to define a length L of the waveguide. The length L of the waveguide extends in a light propagation direction of the waveguide 1 when light is guided through the waveguide 1.

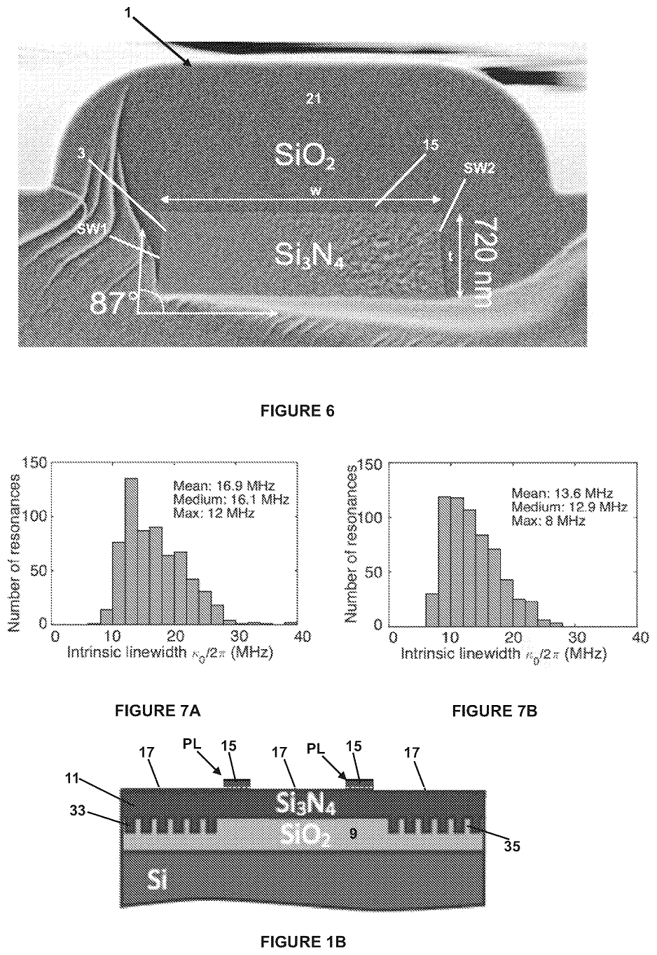

The waveguide core 3 has a thickness t extending in a direction (substantially) perpendicular to the light propagation in the waveguide 1, and a width w extending also in a direction (substantially) perpendicular to light propagation in the waveguide 1 and (substantially) perpendicular to the direction in which the thickness t extends (see, for example, FIG. 6). The optical waveguide 1 and the waveguide core 3 may extend linearly and/or in a curved manner. The optical waveguide 1 and the waveguide core 3 may extend to define a curved or ring waveguide, and may extend to define an optical resonator/microresonator. The fabrication method can produce a plurality of waveguides and the resulting structure may include the plurality of waveguides 1. These waveguides 1 may have the previously mentioned structure and form and may be arranged to assure light coupling and/or distribution between waveguides 1. Waveguides 1 may, for example, be positioned relative to one another to assure light coupling from one waveguide to another by, for example, evanescent coupling. Light coupling to a waveguide 1 may also be carried via an exposed outer cross-sectional facet of the waveguide 1. For example, an optical waveguide 1 comprising a straight bus waveguide may be included that is coupled to an optical waveguide forming a ring-resonator. The waveguides may, for example, have the same (or substantially the same) cross-sectional dimensions in terms of thickness t and width w. The resulting fabricated structure may define one or more photonic integrated circuits. The waveguides may, for example, be tapered, or include a tapered extremity.

The fabrication method includes providing at least one substrate 5 including at least one or a plurality of stress release trench structures 7 (see, for example, stage number 2 of FIG. 1A). The stress release trench structure 7 will receive a waveguide material or waveguide core material that is silicon nitride Si₃N_{4.}

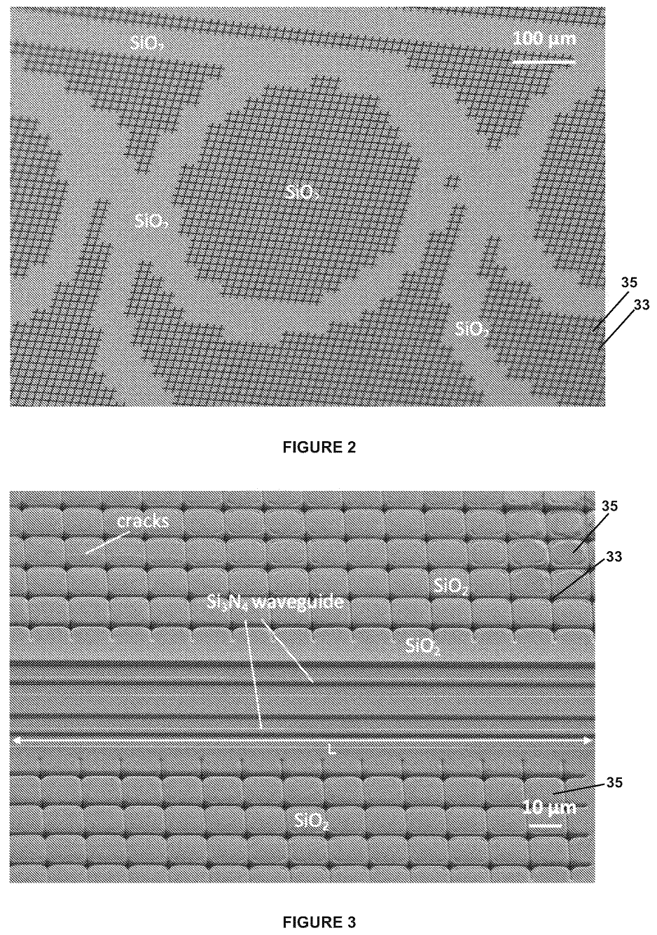

The substrate 5 includes at least one or a plurality planar zones 8. The planar zone 8 is a stress release trench structure-free zone. The planar zone 8 defines a surface SC upon which one or more waveguide cores 3 are formed. The planar zone 8 is, for example, enclosed or surrounded by one or more stress release trench structures 7 (see, for example, FIG. 2). The stress release recess structures 7 are formed in a silicon oxide SiO₂ layer or material 9. The silicon oxide SiO₂ layer or material 9 forms, for example, a lower cladding layer or material of the waveguide 1.

The fabrication method further includes depositing a silicon nitride Si₃N₄ layer or material 11 onto the silicon oxide SiO₂ layer or material 9, and into the stress release recess structures 7. The silicon nitride Si₃N₄ layer or material 11 is deposited onto and into the stress release recess structures 7, and onto the exposed surface SC of the planar zones 8 (see, for example, stage number 3 of FIG. 1A).

Silicon nitride can be deposited, for example, by low-pressure chemical vapor deposition (LPCVD) or plasma-enhanced low-pressure chemical vapor deposition as known to the skilled person (see, for example, Jaeger, Richard C. (2001), “Thermal Oxidation of Silicon”. Introduction to Microelectronic Fabrication, Upper Saddle River: Prentice Hall, ISBN 978-0-201-44494-0, the entire contents of which are incorporated herein by reference).

The silicon nitride Si₃N₄ material deposition of the silicon nitride Si₃N₄ layer or material 11 onto the silicon oxide SiO₂ layer or material 9 is, for example, carried out solely once, or in a single material deposition step. This assures a less complex and more efficient fabrication. This also permits to remove any boundary or interface that forms during multiple Si₃N₄ depositions, to assure more uniform waveguide core properties.

FIGS. 5A and 5B show etching end point graphs of a Si₃N₄ waveguide with two Si₃N₄ deposition steps (FIG. 5A) and with a single Si₃N₄ deposition step (FIG. 5B). In FIG. 5A, an end point in the middle of the waveguide etching is a clear evidence that the boundary or interface is present between the two Si₃N₄ deposited layers, this is absent in single deposition layer of FIG. 5B. This boundary or interface produced by the two step deposition process can result in undesired property changes in the Si₃N₄ waveguide and optical loss via light scattering which is thus advantageously eliminated by the single the Si₃N₄ material deposition that forms the waveguide core 3 in the method of the present disclosure. The Si₃N₄ waveguide material or the Si₃N₄ waveguide core 3 consists solely of Si₃N₄ material deposited in only one sole material deposition step, or non-multiple Si₃N₄ material deposition steps.

A thickness t of the deposited silicon nitride Si₃N₄ layer or material 11 may, for example, be ≥600 nm, or a thickness t where 2000 nm≥t≥600 nm.

At least one silicon oxide SiO₂ hard mask 15 is provided on the deposited silicon nitride 11 (see, for example, FIG. 1B), to provide one or more exposed silicon nitride surfaces 17 delimited by the silicon oxide SiO₂ hard mask 15 and defined by the deposited silicon nitride 11.

The silicon oxide SiO₂ hard mask 15 includes or defines one or more elongations PL (see, for example, FIG. 1B) extending on (or on top of) the deposited silicon nitride 11 (for example, directly in contact with the deposited silicon nitride 11). The elongations PL extend, for example, in the form of an elongated structure or waveguide, for example, in a light propagation direction of the waveguide 1.

Providing the at least one silicon oxide hard mask 15 includes depositing a silicon oxide SiO₂ layer or material 19 on the deposited silicon nitride layer or material 11 which is subsequently patterned or structured to provide the silicon oxide hard mask 15 (see, for example, stage numbers 4 and 5 of FIG. 1A, and FIG. 1B). The silicon oxide hard mask layer or material 19 is, for example, deposited by low-pressure chemical vapor deposition LPCVD. The silicon oxide hard mask is grown, for example, based on the LPCVD TEOS (tetraethyl orthosilicate Si(OC₂H₅)₄)) process. It employs the dissociation of TEOS at low pressure, e.g. 250 mTorr, and at temperatures exceeding 600° C.: Si(OC₂H₅)₄→SiO₂+2C₂H₄+H₂O. A layer thickness between 0.5 microns and 1 micron may, for example, be deposited.

The deposited silicon nitride layer or material 11 is subsequently patterned or structured by carrying out deep ultraviolet (DUV) photolithography to pattern the deposited silicon oxide SiO₂ layer or material 19 provided on the deposited silicon nitride (Si₃N₄) layer 11, to pattern and structure the silicon oxide SiO₂ layer or material 19 and provide the silicon oxide hard mask 15 including or defining the one or more elongations PL.

Photolithography or UV lithography is used to transfer a (geometric) pattern or structure from a photomask or optical mask PM to the deposited silicon oxide SiO₂ layer or material 19. Deep ultraviolet (DUV) photolithography using, for example, light of wavelength<400 nm, for example, in the range 193 nm-254 nm illuminates the photomask PM to define an exposure pattern on and in the deposited silicon oxide SiO₂ layer or material 19 such that the resulting pattern formed on the deposited silicon oxide SiO₂ layer or material 19 can be transferred into the underlying silicon nitride (Si₃N₄) layer 11.

The DUV light is passed through, for example, a chrome-on-quartz photomask, whose opaque areas act as a stencil of the desired pattern. The DUV light exposed areas of the deposited silicon oxide SiO₂ layer or material 19 then undergo an etching using, for example, C₄F₈ and He to remove these areas (the deposited silicon oxide SiO₂ layer or material 19 remains in areas where the photomask PM blocked light exposure to form the silicon oxide SiO₂ hard mask 15) and produces the exposed silicon nitride areas or surfaces 17 of the underlying silicon nitride material or layer 11 that can be subsequently processed.

An ASML PAS 5500/350C Deep-UV stepper photolithography tool was, for example, used, for example, to expose and produce the silicon oxide SiO₂ hard mask 15.

The above-described approach is a positive photoresist exposure approach. Alternatively, a negative photoresist exposure approach may also be used using negative photoresist.

The fabrication method further includes dry etching the exposed surfaces 17 to form one or more silicon nitride Si₃N₄ elongated waveguide cores 3 located between the silicon oxide SiO₂ hard mask 15 and the silicon oxide SiO₂ layer or material 9 in which the stress release trench structures 7 are formed (see, for example, stage number 5 of FIG. 1A).

Dry etching of the exposed surfaces 17 is carried out to remove the deposited silicon nitride material 11 between the exposed surface 17 and the silicon oxide layer or material 9 containing the stress release recess structures 7, or in which the stress release recess structures 7 are formed.

Dry etching the exposed surfaces 17 exposes first and second side walls SW1, SW2 of the silicon nitride Si₃N₄ waveguide core 3. The side walls SW1, SW2 extend away from the silicon oxide SiO₂ hard mask 15 and towards the substrate 5. The side walls SW1, SW2 may extend, for example, between the silicon oxide SiO₂ hard mask 15 and the silicon oxide SiO₂ layer or material 9. Dry etching may, for example, be carried out to remove the silicon nitride material 11 to expose the surface SC (or a portion thereof) of the planar zone or zones 8.

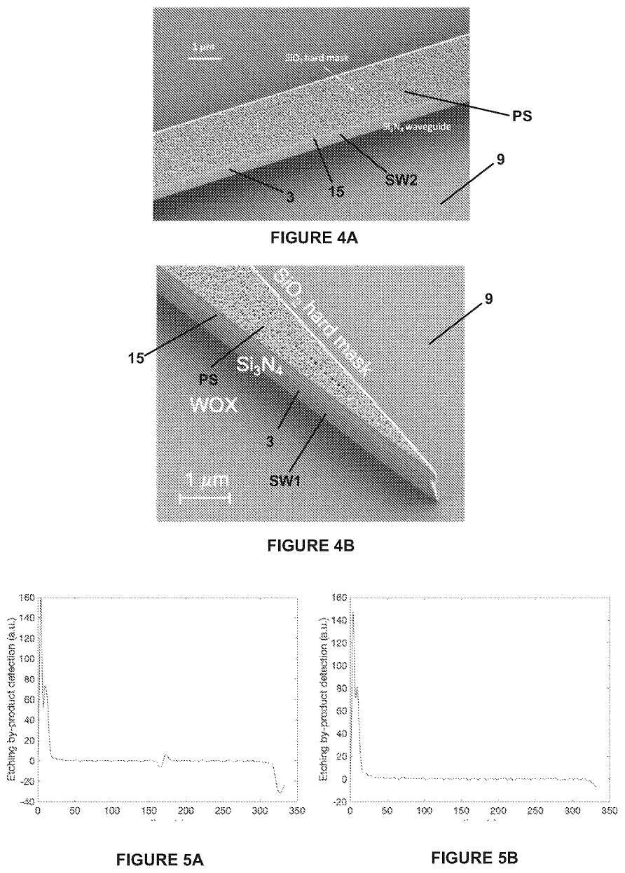

Dry etching forms a porous surface PS on the silicon oxide (SiO₂ ) hard mask 15 or forms pores in the silicon oxide (SiO₂ ) hard mask 15 (see, for example, FIGS. 4A and 4B).

Etching is carried out to such that the silicon nitride Si₃N₄ elongated waveguide core 3 has, for example, a height or thickness t≥600 nm, or a thickness t where 2000 nm≥t≥600 nm, or 1000 nm>t≥600 nm, or 830 nm>t≥600 nm. The silicon nitride Si₃N₄ elongated waveguide core 3 has, for example, a width w where 4000 nm>w>600 nm. The length L of the elongated waveguide core 3 is, for example, application dependent and can typically be several millimeters or more in value.

Dry etching or plasma etching to form the silicon nitride elongated waveguide core 3 comprises, for example, carrying out anisotropic dry etching carried out using, for example, CₓF_{y}-based chemical substances. Oxygen, may, for example, be added in order to remove CF polymers created as an etching by-product. Etching can, for example, be carried out with CHF₃ and SF₆, and with O₂ also, serving to remove the etching by-product from chemical reactions between Si₃N₄ and CHF₃/SF₆.

FIG. 4A is a side-view scanning electron microscopic image of a silicon nitride waveguide 3 after etching using the silicon oxide hard mask 15 to remove surrounding silicon nitride material 11, corresponding to the stage indicated by the number 5 in FIG. 1A. The porous top part or top surface PS in the image is the outer or top surface of the silicon oxide hard mask 15 after silicon nitride waveguide etching. The pores will be filled during cladding 21 deposition. A smooth side wall SW2 of the silicon nitride waveguide 3 extending downwards from the top surface to the thermal silicon oxide 9 are also visible in the image.

FIG. 4B is another side-view scanning electron microscopic image of the etched waveguide material 11 showing the pores on the top surface of SiO₂ hard mask 15 resulting from chemical reactions with the CₓF_{y} etchants. The smooth sidewall SW1 of the etched waveguide material 11 is also visible in the image.

A silicon oxide SiO₂ cladding (or passivation) layer or material 21 is deposited on the silicon oxide SiO₂ hard mask 15, subsequent to dry etching of the exposed surfaces 17, to form a (upper) cladding structure or covering CS of the silicon nitride waveguide 1 or waveguides 1 (see, for example, stage number 7 of FIG. 1A). The thickness of the silicon oxide SiO₂ cladding (or passivation) layer or material 21 is, for example, between 0.5 microns and 2.5 microns, for example, 1 micron.

The silicon oxide hard mask 15 and the silicon oxide cladding layer or material 21 deposited onto the silicon oxide hard mask 15 form the cladding structure CS (or are a part thereof) of the silicon nitride waveguide 1.

Advantageously, both the silicon oxide hard mask layer or material 19 used to form the hard mask 15 and the silicon oxide SiO₂ cladding layer 21 are, for example, deposited by the same deposition method. The silicon oxide SiO₂ cladding layer 21 may, for example, be also deposited by low-pressure chemical vapor deposition LPCVD. The silicon oxide cladding layer 21 is similarly deposited at low pressure, for example, based on the LPCVD TEOS (tetraethyl orthosilicate Si(OC₂H₅)₄)) process. It employs the dissociation of TEOS at low pressure, e.g. 250 mTorr, and at a temperature exceeding 600° C. The deposition can be expressed as: Si(OC₂H₅)₄→SiO₂+2C₂H₄+H₂O.

The silicon oxide SiO₂ cladding layer or material 21 is deposited, for example, on the silicon oxide SiO₂ hard mask 15, the silicon nitride elongated waveguide core or cores 3 and the stress release recess structures subsequent to dry etching the exposed surfaces 17.

Deposition of the silicon oxide SiO₂ cladding layer or material 21 forms, for example, a cladding or cladding covering on the (exposed) side walls SW1, SW2.

The silicon oxide cladding layer or material 21 is deposited on the porous surface PS or into the pores of the silicon oxide hard mask 15, and fills the pores.

The optical waveguide 1 (or each optical waveguide) comprises a single deposition silicon nitride Si₃N₄ layer or material, or solely one silicon nitride Si₃N₄ deposition between the lower cladding SiO₂ material or layer 9 and the upper or opposite cladding SiO₂ material or layer 21. The (one and/or the same) single deposition silicon nitride Si₃N₄ layer or material directly contacts the lower cladding SiO₂ material or layer 9 and the upper or opposite cladding SiO₂ material or layer 21. The single deposition silicon nitride Si₃N₄ layer or material is boundary-less or interface-less with any other silicon nitride Si₃N₄ layer or material.

Thermal annealing may, for example, be carried out subsequent to dry etching and before deposition of the silicon oxide cladding layer or material 21 to remove hydrogen or to break hydrogen bonds (for example, O—H bonds, and/or Si—H bonds). Thermal annealing may, for example, be additionally or alternatively carried out subsequent to the deposition of the silicon oxide cladding layer or material 21 to remove hydrogen or to break hydrogen bonds (for example, O—H bonds, and/or Si—H bonds).

Thermal heating or annealing of the processed or fabricated structure or device can, for example, be carried out by heating in an oven or a furnace, for example, in a controlled atmosphere, for example, a nitrogen atmosphere. However, different methods can be used, for example, annealing in a chlorine atmosphere, or annealing using UV light. The annealing temperature can, for example, be carried out for a duration between 10 and 35 hours and the annealing temperature may, for example, between 1100° C. and 1200° C. For example, annealing can be performed for 11 hours at a temperature of 1200° C.

The substrate 5 including the stress release trench structures 7 may, for example, be a silicon oxide substrate. The substrate 5 comprises or consists of a silicon oxide layer or material in which the stress release trench structures 7 are formed. The substrate 5 may, for example, comprise or consist of silicon, sapphire, silicon carbide, lithium niobate, fused silica, or quartz. The substrate 5 may comprise or consist of silicon, and the silicon oxide SiO₂ layer or material 9 may be formed or grown by thermal (wet) oxidation on the silicon substrate. During oxidation, the top-most silicon (Si) atoms of the substrate are converted to SiO₂ by, for example, flowing oxygen through a high-temperature furnace tube.

The stress release trench structures 7 comprises at least one or a plurality of indentations or depressions 33 formed in the silicon oxide SiO₂ layer or material 9 (FIGS. 1A, 1B). The at least one or the plurality of indentations or depressions 33 define or delimit one or more silicon oxide pillars or supports 35. The plurality of indentations or depressions 33 are filled with silicon nitride material 11 when this material is deposited onto the SiO₂ material or layer 9. The stress release trench structure 7 prevents cracks forming or propagating to or into the waveguide core 3 or waveguide device 1. The stress release trench structure or structures 7 enclose, for example, the waveguide cores 3 or waveguide devices 1 to prevent crack propagation to the waveguide cores 3 or waveguide devices 1.

A depth of the indentations 33 measured from an outer surface of the silicon oxide material or layer 9 and extending into the silicon oxide material or layer 9 may, for example, be substantially equal to or greater than the thickness t of the at waveguide core 3. A depth of the indentation 33 may, for example, be between 1.5 microns and 5 microns, for example 2.5 microns. A depth of the indentation 33 may, for example, be ≥3 microns, for example, ≥3 microns and ≤5 microns or 10 microns, for example 3.5 microns. This prevents cracks forming or extending through or across the optical waveguide or waveguide core 3. The depth direction being in a direction perpendicular to the plane of extension defined by the substrate 5, or perpendicular to the elongated guiding direction or propagation direction of light in the waveguide core 3.

An indentation-free zone 8 may, for example, separate stress release trench structures 7 or groupings of indentations 33 and pillars 35, such a separation distance D may be, for example, 2 μm<D<50 μm. The waveguide core 3 and the stress release trench structure 7 are, for example, located at different levels or in different planar level or planes of the silicon oxide material or layer 9. The waveguide core 3 is, for example, located above or at a higher level than the stress release trench structure 7. Light guiding or propagation in the waveguide core 3 is above the stress release trench structure 7.

The plurality of indentations 33 may be, for example, regularly or irregularly spaced one from the other. The plurality of indentations may form, for example, at least one repeating pattern of indentations across the silicon oxide material or layer 9. The plurality of indentations 33 may form, for example, a checkerboard structure or layout across the SiO₂ material or layer 9.

The stress release recess structure or structures 7 are formed, for example, by carrying out photolithography to pattern a photoresist layer 37 deposited on the silicon oxide (SiO₂ ) layer or material 9, and carrying out subsequent dry etching.

DUV Photolithography or UV lithography is, for example, used to transfer a (geometric) pattern or structure from a photomask or optical mask 39 to the photosensitive photoresist 37. Deep ultraviolet (DUV) photolithography using, for example, light of wavelength <400 nm, for example, in the range 193 nm-254 nm illuminates the photomask 39 to define an exposure pattern on and in the photoresist 37 such that the resulting pattern can be transferred into the underlying SiO₂ layer or material 9 by dry etching.

The exposure UV or DUV light is passed through, for example, a chrome-on-quartz photomask 39, whose opaque areas act as a stencil of the desired pattern. The photoresist layer 37 may be baked before and/or after light exposure. The exposed photoresist areas then undergo a chemical development to remove unwanted photoresist areas (photoresist remains in areas where the photomask 39 blocked light exposure) and produces areas that are open or exposing portions of the underlying SiO₂ material or layer 9 that can be subsequently etched to provide the substrate 5 including the stress release trench structures 7 (see, for example, stage number 2 of FIG. 1A). The SiO₂ layer 9 is, for example, dry etched with, for example, C₄F₈ and He, to a depth between, for example, 2 and 4 microns.

An ASML PAS 5500/350C Deep-UV stepper photolithography tool was used, for example, to expose and produce the substrate 5 including the stress release trench structures 7. The photoresist coating and development was performed, for example, using an in-line TEL Clean Track ACT-8 tool. The photoresist may, for example, between 1 and 2 microns thick M 108Y (6cP) DUV photoresist from JSR Micro NV, optionally on top of 60 nm of DUV 42P as bottom layer anti-reflective coating (BARC). Coating/exposure/development may be performed, for example, using the standard recipes, for example, as provided by the vendor.

The above-described approach is a positive photoresist exposure approach. Alternatively, a negative photoresist exposure approach may also be used using negative photoresist.

According to a further aspect of the present disclosure, the propagation loss in the Si₃N₄ waveguides 1 can be reduced by carrying out a rapid thermal anneal (RTA). A rapid thermal anneal can, for example, be carried out over a duration between 30 to 90 minutes, and at a temperature between 350° C. and 550° C. to increase a quality factor of the silicon nitride waveguide 1. For example, rapid thermal anneal can be carried out for 60 minutes at a temperature of 500° C. The rapid thermal anneal is carried out on the structure comprising the fabricated waveguide or waveguides 1 including the waveguide core 3 upon which the outer cladding material or layer 21 has been deposited (for example, after stage number 7 of FIG. 1A).

Thermal annealing carried out subsequent to dry etching and before deposition of the silicon oxide cladding layer or material 21 to remove hydrogen or to break hydrogen bonds (for example, O-H bonds, and/or Si-H bonds) and thermal annealing carried out subsequent to the deposition of the silicon oxide cladding layer or material 21 may both be carried out prior to this rapid thermal anneal.

Without being restricted to any particular theory, the Inventors believe that an increase in propagation loss in the Si₃N₄ waveguides may result following exposure to ultraviolet (UV) irradiation and that the rapid thermal anneal permits recovery of this propagation loss.

The Inventors show that an intrinsic quality factor as high as 20×10⁶ at 1.55 μm across a 100 mm wafer can already be achieved using the fabrication method of the present disclosure. This exemplary fabrication is now described.

Si₃N₄ waveguides/PICs were fabricated on a SiO₂ layer 9 grown using thermal wet oxidation on single-crystal silicon wafers 5. In order to release the tensile stress and prevent crack formation, mechanical trenches 33 are created on the SiO₂ layer 9, which define filler patterns, to define boundaries and enclose individual local areas with manageable stress. The mechanical trenches 33 are formed by dry-etching to a depth of (about) 2.5 μm to break force accumulation via periodically interrupting the film continuity.

In contrast to the prevailing two-time deposition approach of the prior art, only one single LPCVD Si₃N₄ film 11 is deposited in a single step, and no cracks are observed thanks to the deep filler patterns 7. The as-deposited Si₃N₄ film 11 has a 1.2% variation in thickness uniformity and a 0.3 nm root mean square (RMS) roughness, which renders a smooth top surface with reduced scattering losses.

The waveguides 3 were then written with a KrF 248 nm deep-ultraviolet (DUV) stepper lithography, and are transferred to the Si₃N₄ layer via anisotropic dry etching with CₓF_{y}-based chemicals.

For superior etch quality and smooth waveguide sidewalls, a LPCVD SiO₂ layer 19 was deposited on top of the Si₃N₄ film 11 to provide an etching hard mask 15, and oxygen was added in the waveguide core 3 etching process in order to remove CF polymers as etching by-product.

The Si₃N₄ waveguide cores 3 are annealed at a high temperature (1200° C.) for 11 hours to drive out excess H₂ and to break the Si-H and N-H bonds.

Cladding of the devices was then performed with 1 μm LPCVD SiO₂ material 21, the same material as the hard mask 15, advantageously permitting to avoid further steps for hard mask removal and to preserve the smoothness of the SizN4 waveguide core 3 top surface.

The same high-temperature treatment was applied to the SiO₂ cladding 21 (1200° C., 11 hours) to consolidate the film and to achieve low absorption losses by driving out the H₂ and breaking the O—H bonds.

More specifically, ring micro-resonators were fabricated with a radius of 455 μm, a height t of 720 nm and a width w of 2.6 μm, coupled to a straight bus waveguide with the same cross-section. This dimension ensures tight confinement. The waveguide cross-section is shown in FIG. 6. The waveguide has a sidewall angle of 87°.

A scanning electron microscopy (SEM) inspection of the sidewall SW1, SW2 reveals a smooth surface. Scanning laser spectroscopy was used to characterize the resonance linewidths of the microresonator (i.e. microresonator loss) from 1350 nm to 1630 nm. The intrinsic loss κ₀/2π for each resonance is extracted, and the histogram of the loss distribution is presented in FIG. 7A. The Inventors characterize the microresonator by the most probable κ₀/2π value, which is 12 MHz, corresponding to an intrinsic quality factor of Q~16.1×10⁶ and a linear loss of ~2.2 dB/m.

Furthermore, the Inventors report an increase in microresonator quality factor with a rapid thermal anneal (RTA) at 500° C. for 1 hour, which they postulate to be an effect of depopulation of defect centers in the silicon nitride layer. The optically active defect centers, such as silicon dangling-bonds, are potentially generated after exposure to ultraviolet (UV) irradiation with an energy larger than the SiₓN_{y} bandgap (~5 eV), which may be present in plasma cleaning or in a UV ozone cleaning procedure.

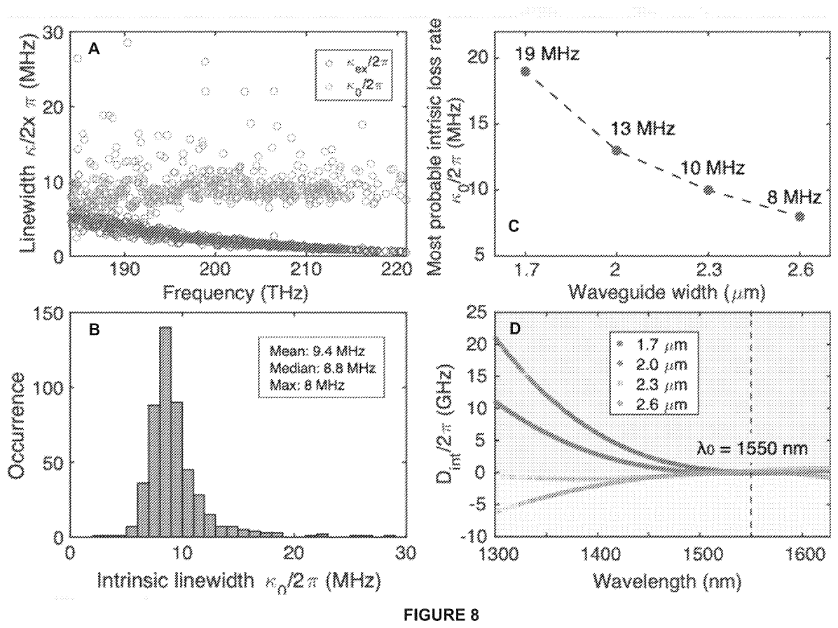

FIGS. 8A to 8D show linear loss measurements of fabricated silicon nitride microresonators with a FSR of 50 GHz. FIGS. 8A and 8B show the intrinsic linewidth distribution and histogram across 1350-1650 nm; while FIGS. 8C and 8D show loss and dispersion dependence on waveguide width.

To annihilate the defect states, rapid thermal annealing of the measured device for 1 hour at 500° C. was performed, the intrinsic loss κ₀/2π histogram of the post-annealed device is presented in FIG. 7B. The most probable intrinsic loss rate is 8 MHz.

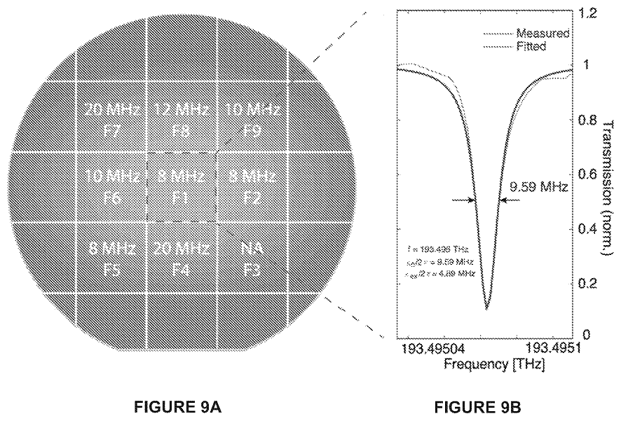

The measurement of wafer-scale loss over nine DUV stepper exposure fields is depicted in FIGS. 9A and 9B. In the central field, one measured normalized transmission spectrum at 1549.4 nm with an intrinsic loss rate of 9.59 MHz is presented in FIG. 9B. This linewidth corresponds to a quality factor of Q~20.17×10⁶ and a linear loss of ~1.7 dB/m.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

1. Silicon nitride waveguide fabrication method including:
providing a substrate including at least one stress release trench structure for receiving a waveguide material the at least one stress release recess structure being formed in a silicon oxide layer or material comprising silicon oxide;
depositing a material or layer comprising silicon nitride onto the layer or material comprising silicon oxide and into the at least one stress release recess structure;
providing at least one hard mask comprising silicon oxide on the deposited material or layer comprising silicon nitride to provide at least one exposed surface delimited by the at least one hard mask comprising silicon oxide and defined by the deposited material or layer comprising silicon nitride the at least one hard mask comprising silicon oxide including or defining at least one elongation extending on the deposited material or layer comprising silicon nitride the at least one elongation extending in the form of an elongated waveguide;
dry etching the at least one exposed surface to form at least one elongated waveguide core comprising silicon nitride located between the at least one hard mask comprising silicon oxide and the layer or material comprising silicon oxide in which the at least one stress release trench structure is formed; and
depositing a cladding layer or material comprising silicon oxide on the at least one hard mask comprising silicon oxide subsequent to the step of dry etching, to form a cladding structure of the silicon nitride waveguide

2. Method according to claim 1, wherein the step of dry etching exposes side walls of the at least one waveguide core comprising silicon nitride and the step of cladding layer or material deposition forms a cladding on the exposed side walls.

3. Method according to claim 1, wherein the deposition of the layer or material comprising silicon nitride is carried out solely once, or in a single deposition step.

4. Method according to claim 1, wherein providing the hard mask comprising silicon oxide includes carrying out deep ultravioletDUV photolithography to pattern a layer comprising silicon oxide provided on the deposited layer or material comprising silicon nitride

5. Method according to claim 1, wherein a layer or material comprising silicon oxide is deposited on the deposited nitride-material or layer comprising silicon nitride and processed to provide the oxide hard mask comprising silicon oxide, and the cladding layer comprising silicon oxide is deposited by the same deposition method as that used for the deposition of the layer or material comprising silicon oxide on the deposited material or layer comprising silicon nitride.

6. Method according to claim 1, wherein dry etching, used to form the at least one elongated waveguide core comprising silicon nitride comprises anisotropic dry etching carried out using CₓF_{y}-based chemical substances.

7. Method according to claim 1, wherein the cladding layer or material comprising silicon oxide is deposited on the hard mask comprising silicon oxide, and on the at least one elongated waveguide core comprising silicon nitride and on the at least one stress release recess structure subsequent to the step of dry etching.

8. Method according to claim 1, wherein thermal annealing is carried out subsequent to the step of dry etching and before deposition of the cladding layer or material comprising silicon oxide to remove hydrogen or to break hydrogen bonds.

9. Method according to anyone claim 1, wherein thermal annealing is carried out subsequent to the deposition of the cladding layer or material comprising silicon oxide to remove hydrogen or to break hydrogen bonds.

10. Method according to claim 1, wherein a rapid thermal anneal is carried out over a duration between 30 to 90 minutes, and at a temperature between 350° C. and 550° C. to increase a quality factor of the silicon nitride waveguide

11. Method according to claim 1, wherein the at least one elongated waveguide core comprising silicon nitride has a height or thickness≥600 nm.

12. Method according claim 1, wherein dry etching of the at least one exposed surface is carried out to remove deposited material comprising silicon nitride located between the at least one exposed surface and the layer or material comprising silicon oxide in which the at least one stress release recess structure is formed.

13. Method according to claim 1, wherein dry etching the at least one exposed surface forms a porous surface on the hard mask comprising silicon oxide, and the cladding layer or material comprising silicon oxide is deposited on the porous surface to fill the pores of the hard mask comprising silicon oxide.

14. Method according to claim 1, wherein the hard mask comprising silicon oxide and the cladding layer or material comprising silicon oxide deposited on the hard mask comprising silicon oxide form a cladding structure of the silicon nitride waveguide.

15. Method according to claim 1, wherein the at least one stress release recess structure is formed by carrying out deep ultraviolet photolithography to pattern a photoresist layer or material deposited on the layer or material comprising silicon oxide, and subsequently carrying out dry etching.

16. Method according to claim 1, wherein a depth of indentations of the at least one stress release trench structure is greater or equal to 3 microns.
